(19) United States
(12) Patent Application Publication
(10) Pub. No.: US 2023/0306583 A1
(43) Pub. Date: Sep. 28, 2023

(54) SYSTEM AND METHOD FOR IMPROVING ADMISSIBILITY OF ELECTRONIC EVIDENCE

(71) Applicant: MOTOROLA SOLUTIONS, INC., CHICAGO, IL (US)

(72) Inventors: PRZEMYSLAW KRZYSTANEK, KRAKOW (PL); MARCIN LUKASIK, KRAKOW (PL); LUKASZ OSUCH, PSZCZYNA (PL); KRZYSZTOF JASINSKI, KRAKOW (PL); PAWEL WILKOSZ, WISNIOWA (PL)

(21) Appl. No.: 18/040,431

(22) PCT Filed: Nov. 10, 2020
(86) PCT No.: PCT/PL2020/050081

§ 371 Date: Feb. 3, 2023

(51) Int. Cl. G06T 7/00; G06Q 50/18

(52) U.S. Cl. CPC G06T 7/001; G06Q 50/18; G06T 2207/20084

(57) ABSTRACT

Techniques for improving admissibility of electronic evidence are provided. An indication that a piece of evidence has been presented to and rejected by a court may be received. The indication includes a reason the piece of evidence was rejected. Metadata related to the piece of evidence is updated in the evidence management system to indicate the reason why the piece of evidence was rejected. Analytics are used to locate additional incidents similar to the incident in the evidence management system. Additional rejected evidence associated with the located incidents that are associated with the piece of evidence that has been rejected by the court based on metadata associated with the additional rejected evidence are identified. Artificial intelligence is used to analyze the rejected evidence and the additional rejected evidence to determine commonalities between the reasons for rejection. A recommended corrective action to prevent future rejection of later gathered evidence is output.

### BACKGROUND

The amount of electronic evidence that may be available for use during court proceedings, both civil and criminal, is ever increasing. Police officers may wear body worn cameras (BWC) to record their interactions with the public. Public safety entities may utilize fixed and Pan Tilt Zoom (PTZ) cameras that cover public spaces. Businesses may have private cameras that cover their own business. Even homeowners may have cameras (e.g. doorbell cameras, home security cameras, etc.) that record video in residential settings. In addition, there may be other types of sensors (e.g. microphones, etc.). All of these devices that may generate digital evidence may be generically referred to as Internet of Things (IoT) devices.

Because this evidence may be used in court, ensuring the integrity of the electronic evidence is vital. Digital evidence management systems (DEMS) have been created to provide secure storage for such digital evidence. DEMS are able to ensure the chain of custody of digital evidence to ensure that the data retrieved from the device (e.g. the BWC, etc.) is accurately entered into the system and by whom. DEMS can also provide digital signatures for the evidence in order to ensure that the evidence has not been altered from the time of its original capture. DEMS can also record everyone who has access to or who has actually accessed a particular piece of evidence.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments

FIG. 1 is a block diagram of an example system that may implement the improving admissibility of electronic evidence techniques described herein.

FIG. 2 is an example of a sequence diagram for implementing the improving admissibility of electronic evidence techniques described herein.

FIG. 3 is an example of a flow diagram for improving admissibility of electronic evidence according to the techniques described herein.

FIG. 4 is an example device that may implement the improving admissibility of electronic evidence according to the techniques described herein.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

DEMS are very cable of receiving digital evidence from the source and ensuring that the evidence is not altered prior to presentation in court. In other words, DEMS make sure that the digital evidence as originally recorded is what the court (e.g. Judges, Jury, defendants, etc.) actually sees.

However, a problem arises in that even though the DEMS system assures that authentic, unmodified digital evidence is presented to the court, this does not ensure that such evidence is admissible. For example, a video clip of an incident (e.g. crime, accident, etc.) may not have been originally recorded in such a way that the subject matter depicted is usable. For example, for a video camera, certain parameters (e.g. zoom, contrast, white balance, etc.) may have been set such that the video image is completely washed out, rendering subjects in the video unidentifiable. In such cases the video may be deemed inadmissible as it provides no value to the court.

As another example, a zoom setting of the camera may have been set such that the Field of View (FoV) of the camera did not capture details relevant to the incident at hand, again rendering the evidence inadmissible. As yet another example, evidence produced by certain devices (e.g. specific vendor, specific software, etc.) may result in inadmissible evidence. Evidence produced in a specific geographic area (e.g. mall parking lot, etc.) could suffer from the same problems related to admissibility.

The techniques described herein overcome these problems, individually and collectively. When a piece of evidence is rejected by a court, the evidence is tagged with metadata indicating the reason why the evidence was deemed inadmissible. The rejected piece of evidence is returned to the DEMS. The DEMS may then scan the database of evidence to identify other evidence that has been rejected for a similar reason. Some example criteria for similar reason could include similar incident types, similar geographic area, similar reason for rejection (e.g. washed out image, etc.), etc.

The system may then use artificial intelligence to identify commonalities between the rejected evidence and detect patterns in the rejected evidence. For example, if evidence produced by cameras of a specific vendor are routinely rejected, the problem may lie within that vendor’s products. If the problem resides with certain camera settings (e.g. white balance, contrast, etc.) that consistently cause evidence to be inadmissible, those settings could be identified.

Once problematic parameters have been identified, corrective action can be taken. For example, updates to static settings (e.g. white balance, etc.) could be sent to the devices. If the problem is associated with a particular vendor, a software update from the vendor may resolve the problem or may indicate the vendor’s devices should be replaced. In some cases, the parameters may be dynamic and based on context. For example, a car accident context may need to have a wide field of view to get a broad picture of what occurred while a kidnapping may need a narrow field of view focused on the suspect in order to be able to recognize the suspect. Intelligent cameras could be programmed to detect the type of incident occurring and set parameters accordingly.

A method is provided. The method includes receiving an indication that a piece of evidence that has been presented to and rejected by a court, the indication including a reason the piece of evidence was rejected by the court, the evidence having been stored in an evidence management system, the evidence being associated with an incident. The method also includes updating, in the evidence management system, metadata related to the piece of evidence to indicate that the piece of evidence was rejected by the court, the metadata further updated to indicate the reason why the piece of evidence was rejected by the court. The method further includes locating, using analytics, in the evidence management system, additional incidents similar to the incident. The method additionally includes identifying additional rejected evidence associated with the located incidents that are associated with the piece of evidence that has been rejected by the court based on metadata associated with the additional rejected evidence. The method includes analyzing, using artificial intelligence, the rejected evidence and the additional rejected evidence to determine commonalities between the reasons for rejection. The method also includes outputting a recommended corrective action to prevent future rejection of later gathered evidence, the recommendation based on the commonalities.

In one aspect, determining commonalities between the reasons for rejection further comprises determining the rejected evidence and the additional rejected evidence were captured with a device type. In one aspect, the recommendation is a suggestion to at least one of replace the device type with a different device type and update software of the device type. In one aspect determining commonalties between the reasons for rejection further comprises determining the rejected evidence and the additional rejected evidence were captured with a device using a common device setting, the common device setting associated with the reason for rejection of the evidence.

In one aspect, the common setting is one of a contrast setting, a zoom setting, and a brightness setting. In one aspect, determining commonalties between the reasons for rejection further comprises determining a common incident type associated with the rejected evidence and the additional rejected evidence. In one aspect the recommendation further comprises altering capture settings of an evidence capture device based on the incident type.

A system is provided. The system includes a processor and a memory coupled to the processor. The memory contains a set of instructions thereon that when executed by the processor cause the processor to receive an indication that a piece of evidence that has been presented to and rejected by a court, the indication including a reason the piece of evidence was rejected by the court, the evidence having been stored in an evidence management system, the evidence being associated with an incident. The instructions further cause the processor to update, in the evidence management system, metadata related to the piece of evidence to indicate that the piece of evidence was rejected by the court, the metadata further updated to indicate the reason why the piece of evidence was rejected by the court. The instructions further cause the processor to locate, using analytics, in the evidence management system, additional incidents similar to the incident. The instructions further cause the processor to identify additional rejected evidence associated with the located incidents that are associated with the piece of evidence that has been rejected by the court based on metadata associated with the additional rejected evidence. The instructions further cause the processor to analyze, using artificial intelligence, the rejected evidence and the additional rejected evidence to determine commonalities between the reasons for rejection. The instructions further cause the processor to output a recommended corrective action to prevent future rejection of later gathered evidence, the recommendation based on the commonalities.

In one aspect, determining commonalities between the reasons for rejection further comprises instructions to determine the rejected evidence and the additional rejected evidence were captured with a device type. In one aspect, the recommendation is a suggestion to at least one of replace the device type with a different device type and update software of the device type. In one aspect, determining commonalties between the reasons for rejection further comprises instructions to determine the rejected evidence and the additional rejected evidence were captured with a device using a common device setting, the common device setting associated with the reason for rejection of the evidence.

In one aspect, the common setting is one of a contrast setting, a zoom setting, and a brightness setting. In one aspect, determining commonalties between the reasons for rejection further comprises instructions to determine a common incident type associated with the rejected evidence and the additional rejected evidence. In one aspect, the recommendation further comprises instructions to alter capture settings of an evidence capture device based on the incident type.

A non-transitory processor readable medium is provided. The medium contains a set of instructions thereon that when executed by the processor cause the processor to receive an indication that a piece of evidence that has been presented to and rejected by a court, the indication including a reason the piece of evidence was rejected by the court, the evidence having been stored in an evidence management system, the evidence being associated with an incident. The instructions further cause the processor to update, in the evidence management system, metadata related to the piece of evidence to indicate that the piece of evidence was rejected by the court, the metadata further updated to indicate the reason why the piece of evidence was rejected by the court. The instructions further cause the processor to locate, using analytics, in the evidence management system, additional incidents similar to the incident. The instructions further cause the processor to identify additional rejected evidence associated with the located incidents that are associated with the piece of evidence that has been rejected by the court based on metadata associated with the additional rejected evidence. The instructions further cause the processor to analyze, using artificial intelligence, the rejected evidence and the additional rejected evidence to determine commonalities between the reasons for rejection. The instructions further cause the processor to output a recommended corrective action to prevent future rejection of later gathered evidence, the recommendation based on the commonalities.

In one aspect, determining commonalities between the reasons for rejection further comprises instructions to determine the rejected evidence and the additional rejected evidence were captured with a device type. In one aspect, the recommendation is a suggestion to at least one of replace the device type with a different device type and update software of the device type. In one aspect, determining commonalties between the reasons for rejection further comprises instructions to determine the rejected evidence and the additional rejected evidence were captured with a device using a common device setting, the common device setting associated with the reason for rejection of the evidence.

In one aspect, the common setting is one of a contrast setting, a zoom setting, and a brightness setting. In one aspect, determining commonalties between the reasons for rejection further comprises instructions to determine a common incident type associated with the rejected evidence and the additional rejected evidence. In one aspect, the recommendation further comprises instructions to alter capture settings of an evidence capture device based on the incident type.

Further advantages and features consistent with this disclosure will be set forth in the following detailed description, with reference to the figures.

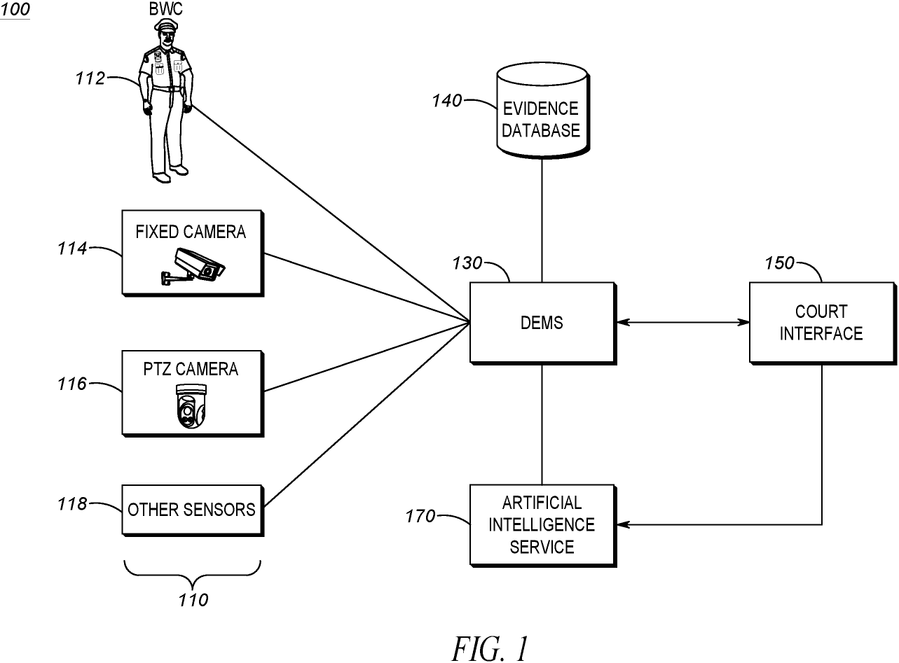

FIG. 1 is a block diagram of an example system that may implement the improving admissibility of electronic evidence techniques described herein. System 100 may include a plurality of IoT devices 110, a DEMS 130, an Evidence Database 140, a court 150, and an Artificial Intelligence (AI) service 170.

IoT devices 110 may be any type of electronic device that is capable of capturing electronic data that can later be used as evidence in court. For example, IoT device 112 may be a BWC worn by a police officer during his shift. The BWC may capture the officer’s interactions with the public and such recorded interactions may later be used as evidence in court. Although a BWC has been mentioned in the context of law enforcement, it should be noted that others may also wear body worn camera’s (e.g. utility workers, hospitality workers, etc.). What should be understood is that the BWC may produce video recordings that are later used as evidence in court.

Other examples of IoT devices 110 may include security cameras such as fixed camera 114. Fixed cameras, as the name implies, have a FoV that is fixed at the time of installation. Changing the FoV is not possible without physically visiting the location where the camera is installed and manually adjusting the camera. Although the camera’s FoV may not be changed remotely, in some cases, parameters of the camera may be changed remotely. Such parameters may include software version, video capture parameters (e.g. contrast, white balance, etc.), and other such parameters. Even if such parameters are not remotely adjustable, they could still be adjusted via physical camera site visit.

Another example of IoT devices 110 may include Pan, Tilt, Zoom (PTZ) camera 116. A PTZ camera 116 is similar to a fixed camera 114, with the exception that the FoV of the PTZ camera may be remotely adjusted. The field of view may be adjusted by panning the camera (side to side motion), tilting the camera (up - down motion), or zooming the camera (narrow field of view - broad field of view). The other parameters with respect to the fixed cameras 114 described above are equally applicable to the PTZ cameras 116.

Although the IoT devices describe thus far have been different types of cameras, it should be understood that the techniques described herein are not limited to cameras. Other Sensors 118 could be any other type of IoT device that generates electronic data that could be used (and potentially rejected by) a court. Such sensors could include audio sensors, traffic sensors, motion sensors, shot spotter gunshot detection systems, etc. Any type of sensor that can capture electronic data usable for evidence and that has at least one adjustable parameter are suitable for use with the techniques described herein.

System 100 may also include a DEMS 130. As mentioned above, DEMS 130 provides a management system for securely storing and authenticating electronic evidence. DEMS 130 may be coupled directly or indirectly to the IoT devices 110. In a direct coupling, the IoT devices may have a direct electronic connection to the DEMS 130. In an indirect coupling, the IoT electronic evidence may be uploaded by a user of the IoT Device 110 into the DEMS. In either case, the DEMS may be used to ensure that the evidence has not been altered and also maintain a chain of custody for the evidence.

Evidence database 140 may be coupled to the DEMS 130 to store the electronic evidence. The electronic evidence stored in evidence data base may include metadata related to the evidence. For example, time, date place the evidence was captured, parameters of the device that was used to capture the electronic evidence, the incident type related to the incident to which the electronic evidence applies, and hashes/digital signatures to prove the electronic evidence has not been tampered with.

In addition, the evidence database may include metadata indicating if a piece of electronic evidence has been previously presented to a court and if that piece of evidence was deemed admissible. If not, the metadata may further include the reason why the piece of electronic evidence was rejected (e.g. contrast set too high, filed of view did not capture subject, etc.). Use of the reasons for rejection will be described in further detail below.

System 100 may also include court interface 150. Court interface 150 is not intended to reflect a physical interface between the courts and the DEMS 130, but rather is intended to depict the interaction of the DEMS and the courts. Electronic evidence stored in the evidence database 140 and managed by the DEMS 130 may be utilized by the courts. In cases where electronic evidence provided by the DEMS 130 is deemed to be inadmissible, the DEMS may receive an indication from the court interface 150 indicating the inadmissibility. The indication may be accompanied with reasons why the electronic evidence was deemed inadmissible. Those reasons may be stored as metadata within the DEMS 130 and evidence database 140. Use of the rejection metadata is described in further detail below.

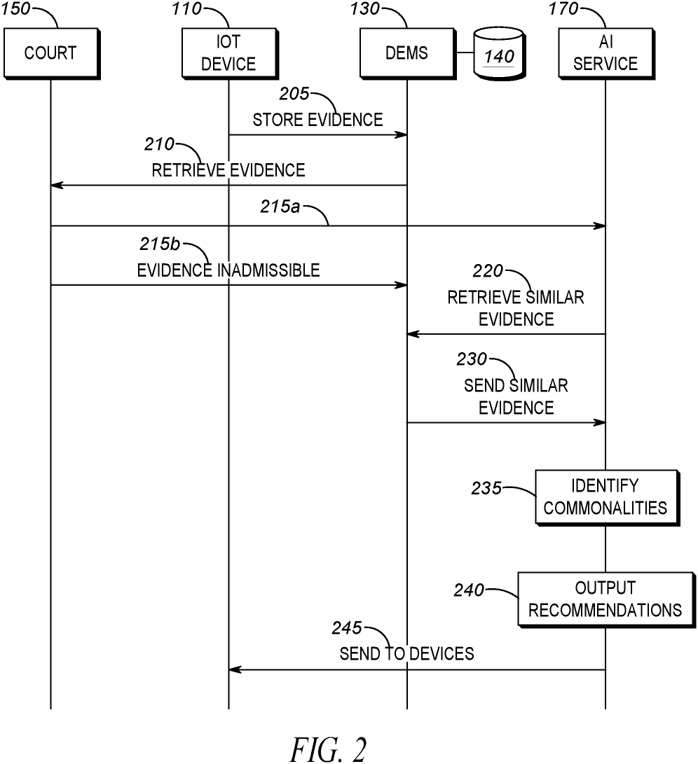

System 100 may also include artificial intelligence service 170. AI service 170 may be used to analyze electronic evidence that has been rejected and compare that rejected evidence with other rejected evidence to detect patterns in the rejections. When patterns in the rejections are found, AI service 170 may provide recommendations as to parameter changes to IoT Device 110 parameters that may be useful to avoid future rejection of evidence from those devices. In some cases, AI service 170 may be able to directly change the parameters on the IoT devices 110. Operation of system 100 is described in further detail with respect to FIG. 2.

FIG. 2 is an example of a sequence diagram for implementing the improving admissibility of electronic evidence techniques described herein. An IoT device 110 may capture a piece of evidence. The IoT device may store the piece of evidence 205 in a DEMS 130. The DEMS 130 may utilize evidence database 140 as the data store. As explained above, DEMS 130 provides for authenticated, tamper proof storage of evidence. For ease of the remainder of the description, it will be assumed that the piece of evidence is a segment of video captured by a PTZ camera, such as PTZ Camera 116. It should be understood that this is for ease of description and not by way of limitation. The piece of evidence could be any type of electronically captured evidence that could be stored in a DEMS.

The captured evidence may be associated with an incident. For example, in a law enforcement context, the incident may be a criminal incident (e.g. assault, battery, murder, etc.). In a broader, public safety context, the incident could be a civil incident (e.g. car accident, accidental fire, etc.). The incident could potentially be between two private parties (e.g. neighbor dispute, etc.). The techniques described herein are not dependent on any particular type of incident, other than the incident is of a type that may need to be resolved in a court of law.

The DEMS 130 will store the piece of evidence in the evidence database 140 along with metadata describing the evidence. Some example metadata could include when and where the evidence was captured. It could include the incident type that the evidence is associated with. It could include the type of IoT device (manufacturer, model, software revision, etc.) that was used to capture the evidence along with the current parameters for the device (e.g. contrast setting, brightness, zoom level, etc.).

At some point the evidence may be retrieved 210 from the DEMS 130 for use in court 150. For example, the evidence may be used in a civil or criminal court proceeding. It should be understood that although there is a direct link shown between the DEMS 130 and the court 150, this is not intended to imply that there is an electronic connection between the two. What should be understood is that the evidence is used for some purpose in court.

In some cases, the evidence may be deemed inadmissible in court for any number of reasons. For example, settings of the video capture device (e.g. contrast, brightness, etc.) may have caused the resulting video to be of such a low quality that the it is not usable to prove / disprove anything in court. For example, if the video was related to an assault incident, the video may be inadmissible if the assailants could not be identified in the video. In another example, a field of view of the camera may have been inappropriate because it was zoomed in too far or not far enough. Consider a car accident incident. If a camera field of view is to narrow, the resulting video may not be useful because it might not have captured the trajectory prior to impact. On the other hand, in the case of a kidnapping incident, too wide a field of view could be a problem because although it may capture the actual abduction, it may not capture the suspect in sufficient detail for identification. What should be understood is that the evidence may be deemed inadmissible by the court for any number of reasons.

An indication that the evidence was inadmissible may be sent 215A and 215B from the court 150 to the DEMS 130 and the AI Service 170. Included in the indication will be the reason why the evidence was rejected by the court (e.g. suspect not identifiable, incorrect field of view, etc.). This information may be stored in the metadata associated with the piece of evidence for later use by the AI service.

The AI service 170 may send a request to the DEMS 130 to retrieve similar evidence 220. Similar evidence means evidence from other similar incidents and/or that was also rejected for similar reasons. It should be understood that similar does not necessarily mean the same. For example, if the evidence deemed inadmissible 215A was related to an assault incident, similar incidents may be assault, battery, terroristic threats, etc. Likewise, if a piece of evidence was rejected because suspects were unidentifiable, a similar reason for rejection could be video too blurry. The DEMS 130 may retrieve the similar rejected evidence from the database 140 and send the similar evidence 230 to the AI Service.

The AI service may then attempt to identify commonalities 235 within the similarly rejected evidence by analyzing the metadata associated with the rejected evidence. As mentioned before, the metadata may include information about the capture device, parameters of the capture device, the incident type associated with the evidence, etc. The artificial intelligence / machine learning field is constantly developing new and improved techniques for detecting similarities and correlating those similarities. The techniques described herein are not dependent on any particular algorithm used to identify commonalities, but instead would be usable with any currently available or later developed algorithms and/or models.

The commonalities that are detected may be relatively simple. For example, all rejected evidence was produced by a camera from a specific vendor. The commonalities could be more complex. For example, all rejected evidence was from cameras from a specific vendor that were running a certain version of software. In some cases, the commonalities could be even more complex. For example, for kidnapping incidents the field of view of the camera was too wide which caused the evidence to be rejected, while for car accident incidents, the rejection was because the field of view was too narrow. What should be understood is that the AI system is able to analyze the rejected evidence and find pieces of the metadata that many of the rejected pieces of data have in common.

It should be further noted that the commonality does not need to be 100%, but rather could be based on a threshold. For example, if some certain percentage (e.g. 80%, etc.) of the rejected evidence have the same commonality, that may be sufficient to indicate that the evidence was rejected for the same base reason. This base reason may then be used to indicate a root cause for rejection of the data.

The AI system 170 may then output recommendations 240 based on the commonalities (e.g. the root cause). For example, if the commonality was determined to be contrast level set too high for a particular camera type, the recommendation could be to reduce the contrast level on all cameras of that type. If the commonality was the rejected evidence was associated with cameras using a certain software version, the recommendation could be to update the software version on those cameras.

Depending on the capabilities of the evidence capture device, the recommendation could be more complex. An example, was provided above in which for kidnapping incidents, the field of view of the camera was too broad, but for car accidents it was too narrow. Some intelligent cameras may be able to detect the type of incident that is occurring. For those cameras, the recommendation could be to use a narrow field of view if kidnapping incident is detected and wide field of view at all other times.

The AI service 170 may send the output recommendations 245 to the IoT devices 110. In cases where the AI service 170 has direct access to the IoT devices, the AI service may itself update parameters of the devices. Even if the AI service 170 does have direct access, the AI service may output the recommendation to a user first to confirm that the updates should be applied. In other cases, the AI service 170 may provide the recommendations to a user who may then manually update the IoT devices 110 based on the recommendations.

Although FIG. 2 has been presented retrospectively in terms of evidence that has been used in court and rejected, there is also a prospective use case. Prior to evidence being presented in court, the same process may occur to retrieve other pieces of evidence that are similar to the present piece (e.g. similar incident type, similar capture device, similar parameters of the capture device, etc.). If a large portion of the retrieved evidence includes metadata that says the evidence was rejected when used in court, an inference can be made that the current piece of evidence will also be rejected. In some cases, it may be possible to reacquire the evidence.

For example, the current piece of evidence may be a police officer’s BWC view of a crime scene during a post incident investigation. Upon analysis, it may be determined that the evidence is likely to be rejected because of some parameter (e.g. contrast level set to high). If the crime scene has not yet been altered, the police officer would be able to change the setting (e.g. lower the contrast setting) and recapture the crime scene.

Even if it is not possible to recapture the evidence, metadata of the evidence could be set to indicate that there is a high likelihood that the evidence will be rejected in court. The user of the evidence may then be made aware that they should not base their case solely around this particular piece of evidence, because of the high probability that the evidence will be rejected.

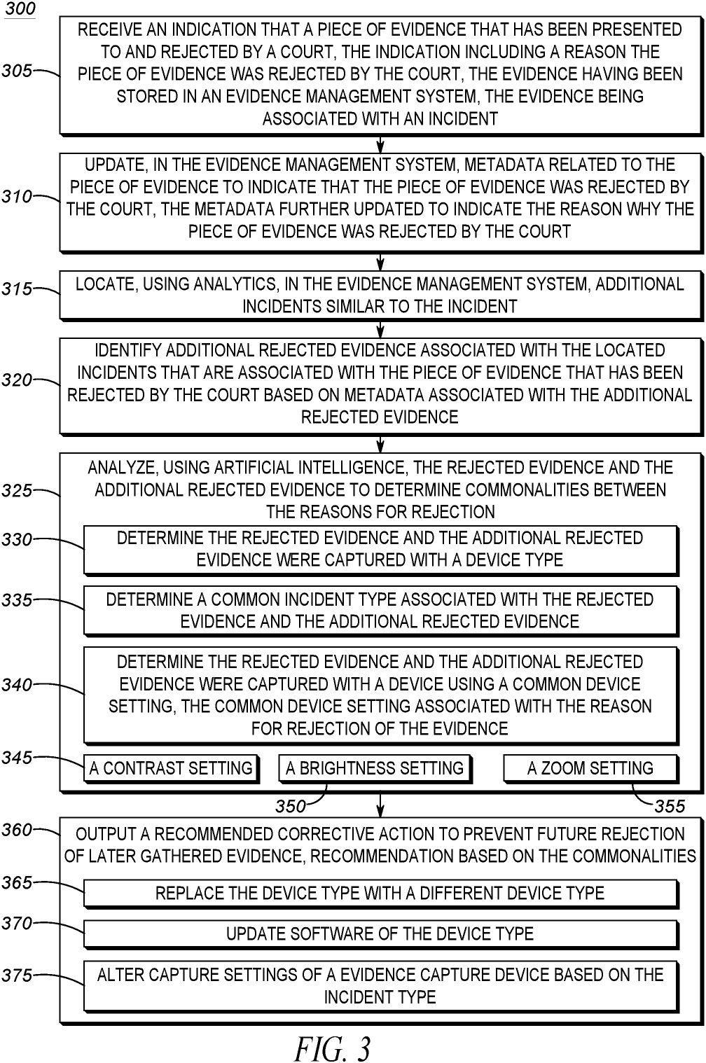

FIG. 3 is an example of a flow diagram 300 for improving admissibility of electronic evidence according to the techniques described herein. In block 305, an indication that a piece of evidence that has been presented to and rejected by a court may be received. The indication may include a reason the piece of evidence was rejected by the court. The evidence may have been stored in an evidence management system, the evidence associated with an incident. In other words, evidence associated with an incident may have been gathered and stored in an evidence management system, such as DEMS 130. When the evidence was presented to a court, the court may have rejected the evidence and provide a reason why the evidence was rejected. The reason for rejection may be provided to the evidence management system.

In block 310, metadata related to the piece of evidence may be updated in the evidence management system to indicate that the piece of evidence was rejected by the court. The metadata may be further updated to indicate the reason why the piece of evidence was rejected by the court. By updating the metadata related to the piece of evidence, the evidence management system is able to keep track of the fact that this particular piece of evidence has been rejected by the court and the reason why the court rejected the piece of evidence. This information may be later used to discover the root cause as to why the evidence was determined to be unacceptable to the court.

In block 315, analytics may be used to locate, in the evidence management system, additional incidents similar to the incident. Locating additional incidents similar to the current incident allows for examination of the evidence that was associated with those incidents to detect commonalities between evidence.

In block 320, additional rejected evidence associated with the located incidents that are associated with the piece of evidence that has been rejected by the court based on metadata associated with the additional rejected evidence may be identified. In other words, a set of incidents that are similar to the current incident (e.g. the same or closely related incident types) are located. The evidence associated with those located incidents is examined to determine if any of the evidence associated with those incidents is similar to the evidence that has been rejected and has been rejected for similar reasons. This can be done by comparing the metadata associated with the rejected evidence with the metadata associated with the evidence of the located incidents.

In block 325, artificial intelligence may be used to analyze the rejected evidence and the additional rejected evidence to determine commonalities between the reasons for rejection. In other words, the evidence of the current incident that has been rejected is compared to evidence associated with similar incidents to identify commonalities in the reason for rejection. Such commonalties may be used to determine the root cause for the reason the evidence was rejected.

In block 330 it may be determined that the rejected evidence and the additional rejected evidence were captured with a device type. For example, all the rejected evidence may have all been captured by a BWC. Going further, all the rejected evidence may have been captured with a BWC from a specific vendor. As another example, all the rejected evidence may have been captured with a PTZ camera, a fixed camera, or some other specific device type.

In block 335, it may be determined if there is a common incident type associated with the rejected evidence and the additional rejected evidence. Although initially similar incident types are located, if the incident types are the same may be determined. For example, if the incident types for all of the rejected evidence is the same incident type.

In block 340, it may be determined that the rejected evidence and the additional rejected evidence were captured with a device using a common device setting and that the common device setting associated with the reason for rejection of the evidence.

For example, in block 345, the common device setting may be a contrast value. If the reason for rejection of the evidence was based on problems with the contrast setting, and rejected evidence was all captured using the same contrast setting, the contrast setting may be a setting of interest. Likewise, in block 350, the common device setting may be a brightness setting. If the reason for rejection of the evidence was based on problems with the brightness setting, and rejected evidence was all captured using the same brightness setting, the brightness setting may be a setting of interest.

As yet another example, in block 355 a zoom setting may be the reason for rejection. For example, if the reason for rejection for all of the evidence was based on field of view being too narrow or too great, the zoom parameter may be a parameter of interest.

Although blocks 325-355 set forth several specific types of commonalities between the rejected evidence, it should be understood that these are merely examples. The techniques described herein may be utilized with any type of commonality between the rejected pieces of evidence. What should be understood is that the artificial intelligence is utilized to discover commonalities amongst all data it has available, whether that be incident type, device type, device parameters, device vendors, device software versions, etc. Using AI to discover commonalities between data sets is known, and any available AI technique would be usable with the techniques described herein. What should be understood is that AI is used to detect commonalities in the reasons for rejection of the evidence.

In block 360, a recommended corrective action may be output to prevent future rejection of later gathers evidence, the recommendation based on the commonalities. In other words, once common reasons for rejection are found, a recommendation may be output to change whatever was found to be common between rejected evidence.

For example, in block 365 the recommendation may be made to replace the device type with a different device type. For example, if it was found that rejected evidence was all captured using a BWC provided by a specific vendor, a recommendation could be output to replace cameras provided by that vendor.

As another example, in block 370 the recommendation may be to update software of the device type. Again, if the commonality found in the rejected evidence is that the capture devices were all using the same software version, the recommendation may be to replace the software of the device type.

Although blocs 365 and 370 were presented as a single commonality, it should be understood that the AI analysis may be more complex, including two, three, or even more levels of commonality. For example, the AI may determine that for a particular incident type, a particular capture setting may result in rejected evidence. For example, for an incident type of kidnapping, a zoom setting with a wide field of view results in rejection (e.g. to wide a field of view does not allow proper identification of kidnapping suspect).

In block 375, the recommended output may be to alter capture settings of an evidence capture device based on the incident type. In the case of an intelligent camera, for example, the recommendation may be to have the camera change a parameter (e.g. zoom in) when it detects a particular type of incident (e.g. kidnapping).

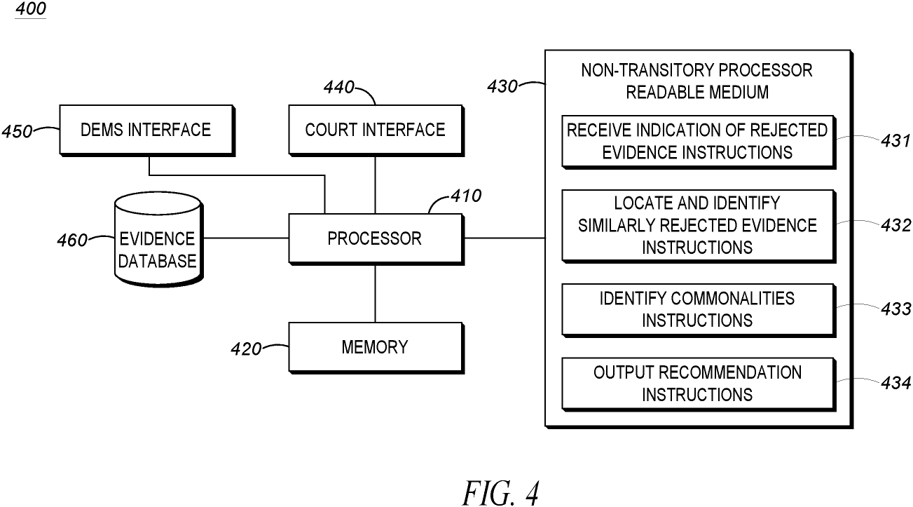

FIG. 4 is an example device that may implement the improving admissibility of electronic evidence according to the techniques described herein. It should be understood that FIG. 4 represents one example implementation of a computing device that utilizes the techniques described herein. Although only a single processor is shown, it would be readily understood that a person of skill in the art would recognize that distributed implementations are also possible. For example, the various pieces of functionality described above (e.g. video analytics, audio analytics, etc.) could be implemented on multiple devices that are communicatively coupled. FIG. 4 is not intended to imply that all the functionality described above must be implemented on a single device.

Device 400 may include processor 410, memory 420, non-transitory processor readable medium 430, court interface 440, DEMS interface 450, and evidence database 460.

Processor 410 may be coupled to memory 420. Memory 420 may store a set of instructions that when executed by processor 410 cause processor 410 to implement the techniques described herein. Processor 410 may cause memory 420 to load a set of processor executable instructions from non-transitory processor readable medium 430. Non-transitory processor readable medium 430 may contain a set of instructions thereon that when executed by processor 410 cause the processor to implement the various techniques described herein.

For example, medium 430 may include receive indication of rejected evidence instructions 431. The instructions 431 may cause the processor to utilize the court interface 440 to receive an indication that a piece of evidence has been rejected by the court. The instructions 431 may further cause the processor to update a DEMS system using the DEMS interface 450 to indicate that a piece of evidence has been rejected and the reasons why the evidence has been rejected.

It should be understood that court interface 440 need not necessarily be a direct interface to the court system. Rather the court interface 440 is intended to describe that the decision to reject a piece of evidence is received from the court through direct electronic entry or via a user interface for manual entry. What should be understood is that the indication that a piece of evidence has been rejected, as well as the reasons why the evidence was rejected, and is updated in the DEMS via the DEMS interface 450. The receive indication of rejected evidence instructions 431 are described throughout this description generally, including places such as the description of blocks 305 and 310.

Medium 430 may include locate and identify similarly rejected evidence instructions 432. The instructions 432 may cause the processor to access the evidence database to locate similar incidents and to find evidence associated with those incidents that has been rejected for reasons similar to the instant rejected evidence. The locate and identify similarly rejected evidence instructions 432 are described throughout this description generally, including places such as the description of blocks 315 and 320.

Medium 430 may include identify commonalities instructions 433. As described above, the artificial intelligence service 170 may examine the rejected evidence to discover commonalities between the rejected evidence. These commonalities may be the root cause of why the evidence was rejected. The identify commonalities instructions 433 are described throughout this description generally, including places such as the description of blocks 325-355.

Medium 430 may include output recommendation instructions 434. The instructions 434 may cause the processor to output recommendations for changes to parameters of the IoT devices 110 based on the commonalities found in the rejected evidence, as those commonalities may indicate the root cause of why the evidence was rejected. The output recommendation instructions 434 are described throughout this description generally, including places such as the description of blocks 360-375.

As should be apparent from this detailed description, the operations and functions of the electronic computing device are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., and cannot [include a particular function/feature from current spec], among other features and functions set forth herein).

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises ... a″, “has ...a”, “includes ... a″, “contains ... a″ does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending in the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through an intermediate elements or devices via an electrical element, electrical signal or a mechanical element depending on the particular context.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method comprising:
receiving an indication that a piece of evidence that has been presented to and rejected by a court, the indication including a reason the piece of evidence was rejected by the court, the evidence having been stored in an evidence management system, the evidence being associated with an incident;
updating, in the evidence management system, metadata related to the piece of evidence to indicate that the piece of evidence was rejected by the court, the metadata further updated to indicate the reason why the piece of evidence was rejected by the court;
locating, using analytics, in the evidence management system, additional incidents similar to the incident;
identifying additional rejected evidence associated with the located incidents that are associated with the piece of evidence that has been rejected by the court based on metadata associated with the additional rejected evidence;
analyzing, using artificial intelligence, the rejected evidence and the additional rejected evidence to determine commonalities between the reasons for rejection; and
outputting a recommended corrective action to prevent future rejection of later gathered evidence, the recommendation based on the commonalities.

2. The method of claim 1 wherein determining commonalities between the reasons for rejection further comprises:
determining the rejected evidence and the additional rejected evidence were captured with a device type.

3. The method of claim 2 wherein the recommendation is a suggestion to at least one of:
replace the device type with a different device type; and
update software of the device type.

4. The method of claim 1 wherein determining commonalties between the reasons for rejection further comprises:
determining the rejected evidence and the additional rejected evidence were captured with a device using a common device setting, the common device setting associated with the reason for rejection of the evidence.

5. The method of claim 4 wherein the common setting is one of:
a contrast setting;
a zoom setting; and
a brightness setting.

6. The method of claim 1 wherein determining commonalties between the reasons for rejection further comprises:
determining a common incident type associated with the rejected evidence and the additional rejected evidence.

7. The method of claim 6 wherein the recommendation further comprises:
altering capture settings of an evidence capture device based on the incident type.

8. A system comprising:
a processor; and
a memory coupled to the processor, the memory containing a set of instructions thereon that when executed by the processor cause the processor to:
receive an indication that a piece of evidence that has been presented to and rejected by a court, the indication including a reason the piece of evidence was rejected by the court, the evidence having been stored in an evidence management system, the evidence being associated with an incident;
update, in the evidence management system, metadata related to the piece of evidence to indicate that the piece of evidence was rejected by the court, the metadata further updated to indicate the reason why the piece of evidence was rejected by the court;
locate, using analytics, in the evidence management system, additional incidents similar to the incident;
identify additional rejected evidence associated with the located incidents that are associated with the piece of evidence that has been rejected by the court based on metadata associated with the additional rejected evidence;
analyze, using artificial intelligence, the rejected evidence and the additional rejected evidence to determine commonalities between the reasons for rejection; and
output a recommended corrective action to prevent future rejection of later gathered evidence, the recommendation based on the commonalities.

9. The system of claim 8 wherein determining commonalities between the reasons for rejection further comprises instructions to:
determine the rejected evidence and the additional rejected evidence were captured with a device type.

10. The system of claim 9 wherein the recommendation is a suggestion to at least one of:
replace the device type with a different device type; and
update software of the device type.

11. The system of claim 8 wherein determining commonalties between the reasons for rejection further comprises instructions to:
determine the rejected evidence and the additional rejected evidence were captured with a device using a common device setting, the common device setting associated with the reason for rejection of the evidence.

12. The system of claim 11 wherein the common setting is one of:
a contrast setting;
a zoom setting; and
a brightness setting.

13. The system of claim 8 wherein determining commonalties between the reasons for rejection further comprises instructions to:
determine a common incident type associated with the rejected evidence and the additional rejected evidence.

14. The system of claim 13 wherein the recommendation further comprises instructions to:
alter capture settings of an evidence capture device based on the incident type.

15. A non-transitory processor readable medium containing a set of instructions thereon that when executed by the processor cause the processor to:
receive an indication that a piece of evidence that has been presented to and rejected by a court, the indication including a reason the piece of evidence was rejected by the court, the evidence having been stored in an evidence management system, the evidence being associated with an incident;
update, in the evidence management system, metadata related to the piece of evidence to indicate that the piece of evidence was rejected by the court, the metadata further updated to indicate the reason why the piece of evidence was rejected by the court;
locate, using analytics, in the evidence management system, additional incidents similar to the incident;
identify additional rejected evidence associated with the located incidents that are associated with the piece of evidence that has been rejected by the court based on metadata associated with the additional rejected evidence;
analyze, using artificial intelligence, the rejected evidence and the additional rejected evidence to determine commonalities between the reasons for rejection; and
output a recommended corrective action to prevent future rejection of later gathered evidence, the recommendation based on the commonalities.

16. The medium of claim 15 wherein determining commonalities between the reasons for rejection further comprises instructions to:
determine the rejected evidence and the additional rejected evidence were captured with a device type.

17. The medium of claim 16 wherein the recommendation is a suggestion to at least one of:
replace the device type with a different device type; and
update software of the device type.

18. The medium of claim 15 wherein determining commonalties between the reasons for rejection further comprises instructions to:
determine the rejected evidence and the additional rejected evidence were captured with a device using a common device setting, the common device setting associated with the reason for rejection of the evidence.

19. The medium of claim 15 wherein determining commonalties between the reasons for rejection further comprises instructions to:
determine a common incident type associated with the rejected evidence and the additional rejected evidence.

20. The medium of claim 19 wherein the recommendation further comprises instructions to:
alter capture settings of an evidence capture device based on the incident type.
